(19) United States
(12) Patent Application Publication
(10) Pub. No.: US 2009/0079704 A1
(43) Pub. Date: Mar. 26, 2009

(54) METHOD AND APPARATUS FOR INPUTTING OPERATION INSTRUCTIONS USING A DUAL TOUCH PANEL OF A MOBILE COMMUNICATION DEVICE

(76) Inventors: Cheng-Wen Huang, Taipei (TW); Guei-Syuan Lin, Taipei (TW)

Correspondence Address: BIRCH STEWART KOLASCH & BIRCH, PO BOX 747, FALLS CHURCH, VA, 22040-0747, US

(21) Appl. No.: 12/200,669

(22) Filed: Aug. 28, 2008

(30) Foreign Application Priority Data
Sep. 21, 2007 (TW) 096135365

(51) Int. Cl. G06F 3/041

(52) U.S. Cl. 345/173

(57) ABSTRACT

A method and an apparatus for inputting operation instructions using a dual touch panel of a mobile communication device are provided. When the user's finger touches the second touch panel of the mobile communication device, the second touch panel detects whether there is a slide path. If no slide path is detected in a predetermined time, a no slide signal will be output. A stop signal as a confirmation key will be output after the touch on the second touch panel ends. If there is a slide path, then it is determined whether the slide path is a one-dimension or two-dimension slide path. If a one-dimension slide path is detected in a predetermined time, a slide direction signal will be output. A stop signal as a direction key will be output after the touch on the second touch panel ends. If a two-dimension slide path is detected, the slide path in each direction is recorded. Each direction is aggregated after the touch on the second touch panel ends and instruction(s) corresponding to the aggregated slide path are executed.

### CROSS-REFERENCE TO RELATED APPLICATIONS

This nonprovisional application claims priority under 35 U.S.C. § 119(a) on Patent Application No. 096135365, filed in Taiwan on Sep. 21, 2007, the entirety of which is incorporated herein by reference.

### BACKGROUND OF THE INVENTION

1. Field of the Invention

The present invention relates to a mobile communication device, and more particularly, to a method and an apparatus for inputting operation instructions using a dual touch panel of a mobile communication device.

2. Background of the Invention

A key structure is a major input apparatus of a mobile communication device. Every key of the key structure usually corresponds to a number, a word, a symbol, roots of the character, various function icons, etc., through which users can input texts or execute the function of the mobile communication device. Therefore, the key structure is an extremely important input apparatus for the mobile communication device.

It is necessary to press several keys to enter a function database or start the execution of the function when a user uses a traditional mobile communication device to execute a function. Worst than that, sometimes, the user may forget a correct sequence of keys needed to be input to execute a function or enter into a database, which causes a lot of inconvenience to the user.

Recently, a lot of functions of mobile communication devices are enhanced. In order to bring more convenience to users, most conventional function shortcut keys which can be manually set are added to the mobile communication device. When the users press a shortcut key or hot key, the function corresponding to the shortcut key will be executed, which makes users execute function more quickly and omits unnecessary operation process. However, this manual setting only allows some of the functions to be set and most of the functions cannot be set due to the limited number of the shortcut key.

Therefore, how to make users input instructions more easily and execute the functions more quickly is one of the most important issues to be solved.

### SUMMARY OF THE INVENTION

In view of the above problems, an object of the present invention is to provide an enlarged touch panel, and the touch panel has a touch region larger than a display area of an LCD of the mobile communication device. The touch panel comprises a first touch panel disposed in front of the LCD and a second touch panel extending from the LCD. By touching the second touch panel or forming a slide path, the user can input instructions to the mobile communication device to perform various functions.

In order to achieve the foregoing object, the present invention provides a method and an apparatus for inputting operation instructions using a dual touch panel of a mobile communication device. When the user's finger touches the second touch panel of the mobile communication device, the second touch panel detects whether there is a slide path. If no slide path is detected in a predetermined time, a no slide signal will be output. A stop signal as a confirmation key will be output after the touch on the second touch panel ends. If there is a slide path, then it is determined whether the slide path is a one-dimension or two-dimension slide path. If a one-dimension slide path is detected in a predetermined time, a slide direction signal will be output. A stop signal as a direction key will be output after the touch on the second touch panel ends. If a two-dimension slide path is detected, the slide path in each direction is recorded. Each direction is aggregated after the touch on the second touch panel ends and instruction(s) corresponding to the aggregated slide path are executed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a flowchart in accordance with an embodiment of the present invention.

FIG. 2 is a front view of a communication device in accordance with an embodiment of the present invention.

FIG. 3 is a side view of a communication device in accordance with an embodiment of the present invention.

FIG. 4 is a schematic view of a communication device in accordance with the first embodiment of the present invention.

FIG. 5 is a schematic view of a communication device in accordance with the second embodiment of the present invention.

FIG. 6 is a schematic view of a communication device in accordance with the third embodiment of the present invention.

FIGS. 7A-7C illustrate schematic views of a communication device in accordance with the fourth embodiment of the present invention.

FIG. 8 is a schematic view of a communication device in accordance with the fifth embodiment of the present invention.

### DETAILED DESCRIPTION OF THE ILLUSTRATED EMBODIMENTS

The present invention will now be described in detail with reference to the accompanying drawings, wherein the same reference numerals will be used to identify the same or similar elements throughout the several views. It should be noted that the drawings should be viewed in the direction of orientation of the reference numerals.

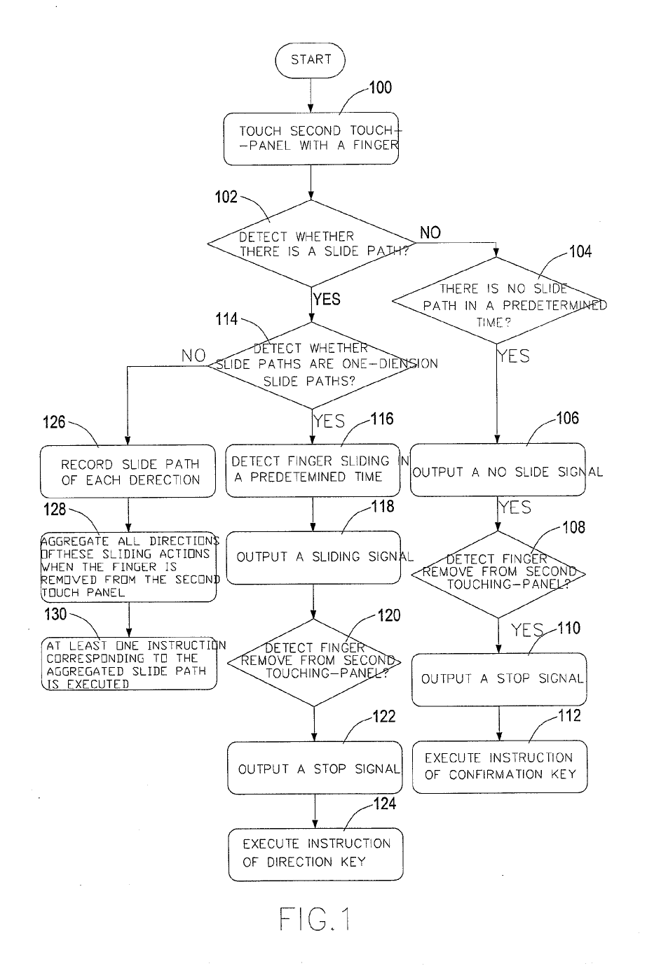

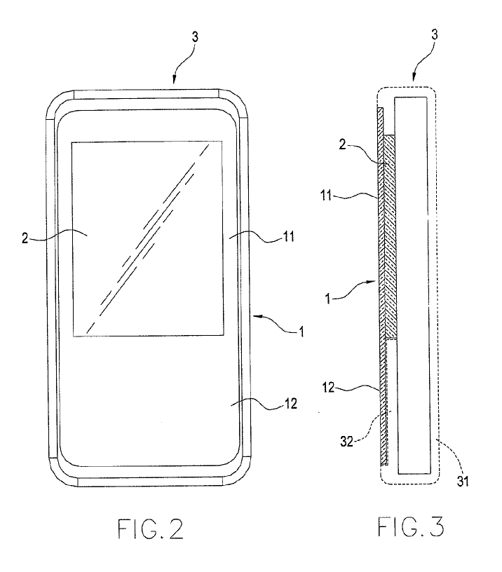

FIG. 1 is a flowchart to input instructions in accordance with an embodiment of the present invention. As shown in FIGS. 2-3, the apparatus as embodied comprise an enlarge touch panel 1 which includes a first touch panel 11 disposed in front of the LCD 2 of a communication device and a second touch panel 12 on the carrier 32, which is inside the housing 31 of the mobile communication device 3.

Referring to step 100 in FIG. 1, a user touches the second touch panel 12 with a finger when he starts to use the communication device.

In step 102, the second touch panel 12 detects whether there is a slide path. If there is no slide path in a predetermined time in step 104, step 106 will be executed to output a no slide signal. In step 108-112, a stop signal is output when the finger is removed from the second touch panel 12 (stop touching), and the instruction of the confirmation key (enter) is executed. If there is a slide path, step 114 will be executed.

In step 114, the second touch panel 12 detects whether the slide path is a one-dimension (e.g., beeline) or two-dimension (e.g., discretionary direction) side path. If the slide path is a one-dimension slide path, and the second touch panel 12 detects that the finger is sliding in a predetermined time in step 116, step 118 will be executed to output a sliding signal. In step 120-124, a stop signal is output when the finger is removed from the second touching-panel (stop touching) and then the instruction of the direction key is executed.

In step 114, if the slide path is a two-dimension slide path (e.g., L shape), step 126 will be executed to record the slide path in each direction. In step 128, when the finger is removed from the second touch panel, all of directions for these sliding actions are aggregated. In step 130, at least one instruction (such as Hotkey, bootstrap mode, control of system, switch of touch panel mode, etc.) corresponding to the aggregated slide path is executed.

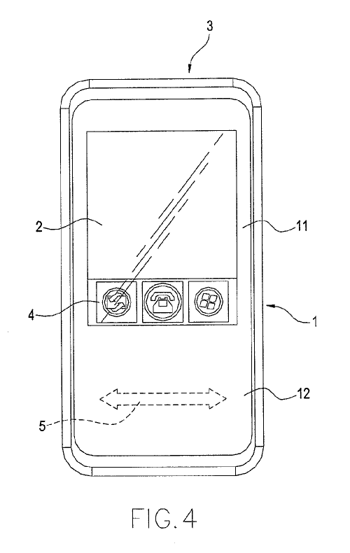

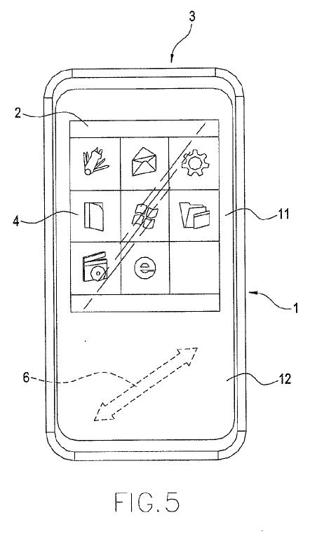

FIG. 4 is a schematic view of the first embodiment of the present invention. Referring to FIG. 4, when a finger touches, slides and stops touching the second touch panel, a continuous slide path 5 is formed on the second touch panel. If the one-dimension slide path 5 either from right to left or from left to right has achieved a predetermined distance (e.g., 25 mm) in a predetermined time (e.g., 0.5 second), a direction key of one scroll item is formed, which executed once means leaping over one icon 4. After the icon 4 is selected, the function according to the icon 4 will be executed if the continuous actions of the finger touching and stopping touch the second touch panel 12 last over 0.5 second, or the user can select the icon 4 on the first touch panel 11 directly. Similarly, when a finger touches, slides and stops touch the second touch panel, a continuous slide path 5 is formed on the second touch panel. If a one-dimension slide path either from up to down or from down to up has achieved a predetermined distance (e.g., 15 mm) in a predetermined time (e.g., 0.5 second), a direction key of one scroll item is formed, which executed once means leaping over one icon 4. When the icon 4 is selected, if the actions of the finger touching and stopping touch the second touch panel 12 last over 0.5 second, the function of the icon will be executed.

The user touches, slides and stops touch the second touch panel with a finger, which causes a continuous slide path 5 to be formed on the second touch panel. If the one-dimension slide path 5 either from right to left or from left to right has achieved a predetermined distance (e.g., 25 mm) in a predetermined time (e.g., over 0.5 second), a direction key of serial scroll items is formed in accordance with the sliding distance. After the icon 4 is selected, the function according to the icon 4 will be executed if the continuous actions of the finger touching and stopping touch the second touch panel 12 last over 0.5 second, or the user can select the icon 4 on the first touch panel 11 directly. Similarly, when a finger touches, slides and stops touch the second touch panel, if the one-dimension slide path 5 either from up to down or from down to up has achieved a predetermined distance (e.g., 15 mm) in a predetermined time (e.g., over 0.5 second), a direction key of serial scroll items is formed in accordance with the sliding distance. When the icon 4 is selected, if the actions of the finger touching and stopping touch the second touch panel 12 last over 0.5 second, the function of the icon will be executed.

FIG. 5 is a schematic view of the second embodiment of the present invention. Referring to FIG. 5, a continuous slide path 6 of the finger touching, sliding and stopping touch the second touch panel is formed on the second touch panel. The one-dimension slide path 6 from bottom right to top left, from top left to bottom right, from top right to bottom left, or from bottom left to top right has achieved a predetermined distance (e.g., 25 mm) in a predetermined time (e.g., over 0.5 second), an oblique direction key is formed. When the icon 4 is selected, if the actions of the finger touching and stopping touch the second touch panel 12 last over 0.5 second, the function of icon will be executed.

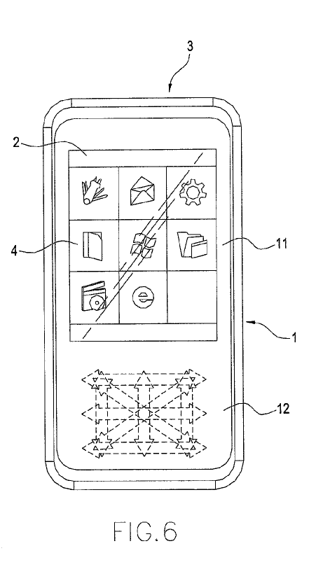

FIG. 6 is a schematic view of the third embodiment of the present invention. Referring to FIG. 6, when the user controls a submenu of a nine-option menu in multi-directions, the direction instructions change with the change of the sliding directions so that the user can select every sub-permutation's icon 4 of the nine-option menu.

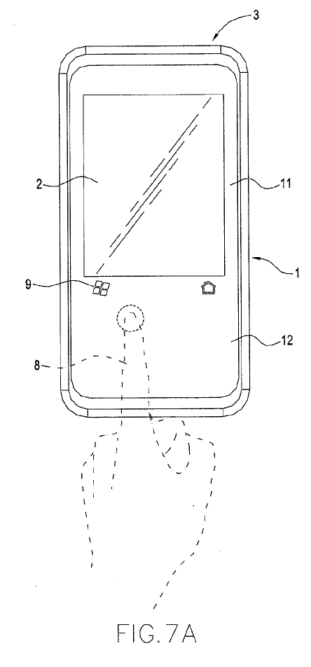

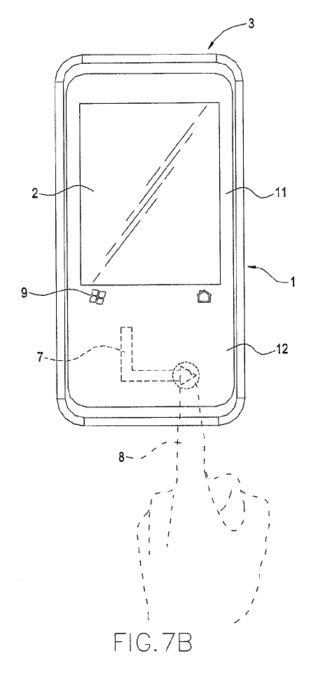

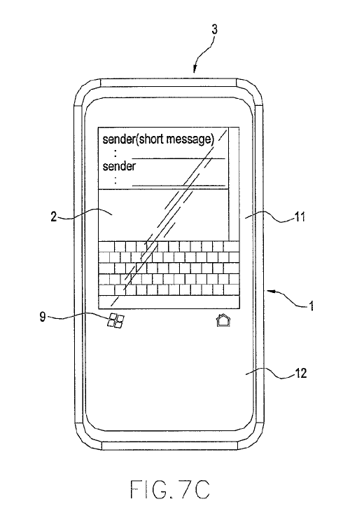

FIGS. 7A-7C are continuous schematic views of the fourth embodiment of the present invention. Referring to FIGS. 7A-7C, when a continuous slide path 7, which is formed by touching, sliding and stopping touch the second panel, is an L shape, the internal system of the mobile communication device 3 will judge which of the instructions corresponds to the slide path 7. For example, if the slide path 7 corresponds to the function of short message editing, the system will execute the function of editing automatically.

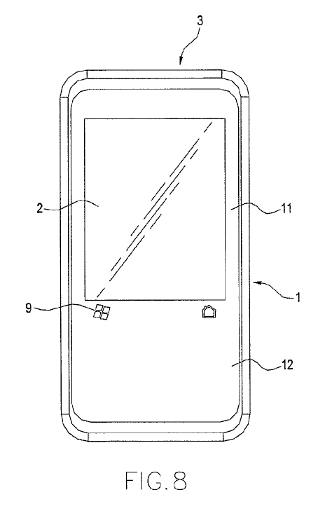

FIG. 8 is a schematic view of the fifth embodiment of the present invention. Referring to FIG. 8, there is a special icon key 9 (e.g., windows/home/call/end) added on the second touch panel. If the special icon key 9 is selected and stayed for 1 second, an instruction corresponding to the special icon key 9 is input. Therefore, the user can execute the function corresponding to the special icon key 9.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for inputting operation instructions using a dual touch panel of a communication device, the dual touch panel including a first touch panel and a second touch panel, the method comprising:
a) when a touch on the second panel is detected, detecting whether there is a slide path in the second touch panel;
b) outputting a no slide signal when no slide path is detected in a first predetermined time, and outputting a stop signal as a direction key after the touch on the second touch panel ends;
c) outputting a slide direction signal when an one-dimension slide path is detected in the first predetermined time, and outputting a stop signal as an inputting instruction of the direction key after the touch on the second touch panel ends;
d) recording the slide path in each direction when a two-dimension slide path is, detected, aggregating the slide path in each direction, and executing at least one instruction corresponding to the aggregated slide path after the touch on the second touch panel ends.

2. The method according to claim 1, wherein when no slide path is detected in the first predetermined time and the touch on the second panel lasts more than a second predetermined time, a confirmation key is executed.

3. The method according to claim 1, wherein when the one-dimension slide path is either from right to left or from left to right in the step c) and achieves a predetermined distance in the first predetermined time, a direction key of one scroll item is formed and an icon is scrolled, which executed once means leaping over one icon.

4. The method according to claim 3, wherein the first predetermined time is 0.5 second.

5. The method according to claim 3, wherein the predetermined distance is 25 mm.

6. The method according to claim 1, wherein when the one-dimension slide path is either from up to down or from down to up in the step c) and achieves a predetermined distance in the first predetermined time, a direction key of one scroll item is formed and an icon is scrolled, which executed once means leaping over one icon.

7. The method according to claim 6, wherein the first predetermined time is 0.5 second.

8. The method according to claim 6, wherein the predetermined distance is 15 mm.

9. The method according to claim 1, wherein when the one-dimension slide path is either from right to left or from left to right in step c) and achieves a predetermined distance in the first predetermined time, a direction key of serial scroll items is formed and icons are scrolled in accordance with a sliding distance.

10. The method according to claim 1, wherein when the one-dimension slide path is either from up to down or from down to up in step c) and achieves a predetermined distance in the first predetermined time, a direction key of serial scroll items is formed and icons are scrolled.

11. The method according to claim 1, wherein when the one-dimension slide path is from bottom right to top left, from top left to bottom right, from top right to bottom left, or from bottom left to top right in step c) and achieves a predetermined distance in the first predetermined time, an oblique direction key is formed.

12. The method according to claim 1, wherein an instruction corresponding to the two-dimension slide path in the step d) is set as one of a Hotkey, a bootstrap mode, a control of system, and switch of a touch panel mode.

13. The method according to claim 1, wherein a special icon key is on the second touch panel, and when the special icon key is touched or stayed for a second predetermined time, an instruction according to a function corresponding to the special icon key is input.

14. An apparatus for inputting operation instructions to a mobile communication device, comprising:
an LCD screen;
a touch panel, comprising a first touch panel disposed in front of the LCD screen, and a second touch panel disposed on a carrier of a housing of the mobile communication device;
wherein when a one-dimension path or a two-dimension slide path is detected in the second touch panel, an instruction is input to a system of the mobile communication device.

15. The operation instructions input apparatus for a dual touch panel according to claim 14, wherein when no slide path is detected in a first predetermined time and a touch on the second panel lasts more than a second predetermined time, a confirmation key is executed.

16. The apparatus according to claim 14, wherein when the one-dimension slide path is either from right to left or from left to right and achieves a predetermined distance in a first predetermined time, a direction key of one scroll item is formed and an icon is scrolled, which executed once means leaping over one icon.

17. The apparatus according to claim 16, wherein the first predetermined time is 0.5 second.

18. The apparatus according to claim 16, wherein the predetermined distance is 25 mm.

19. The apparatus according to claim 14, wherein when the one-dimension slide path is either from up to down or from down to up and achieves a predetermined distance in a first predetermined time, a direction key of one scroll item is formed and an icon is scrolled, which executed once means leaping over one icon.

20. The apparatus according to claim 19, wherein the predetermined time is 0.5 second.

21. The apparatus according to claim 19, wherein the predetermined distance is 15 mm.

22. The apparatus according to claim 14, wherein when the one-dimension slide path is either from right to left or from left to right and achieves a predetermined distance in a first predetermined time, a direction key of serial scroll items is formed and icons are scrolled in accordance with a sliding distance.

23. The apparatus according to claim 14, wherein when the one-dimension slide path is either from up to down or from down to up and achieves a predetermined distance in a first predetermined time, a direction key of serial scroll items is formed and icons are scrolled.

24. The apparatus according to claim 14, wherein when the one-dimension slide path is from bottom right to top left, from top left to bottom right, from top right to bottom left, or from bottom left to top right and achieves a predetermined distance in a first predetermined time, an oblique direction key is formed.

25. The apparatus according to claim 14, wherein an instruction corresponding to the two-dimension slide path is set as one of a Hotkey, a bootstrap mode, a control of system, and switch of a touch panel mode.
